(19) United States
(12) Patent Application Publication
(10) Pub. No.: US 2015/0060163 A1
(43) Pub. Date: Mar. 5, 2015

(54) HYPER-FLUX FLYWHEEL MOTOR SYSTEM

(71) Applicant: Daniel Kee Young Kim, San Francisco, CA (US)

(72) Inventor: Daniel Kee Young Kim, San Francisco, CA (US)

(21) Appl. No.: 14/453,432

(22) Filed: Aug. 6, 2014

Related U.S. Application Data
(60) Provisional application No. 61/863,210, filed on Aug. 7, 2013.

(51) Int. Cl. H02K 7/02; B62D 37/06; B60K 1/00; H02K 7/09; B60L 15/20

(52) U.S. Cl. CPC H02K 7/025; H02K 7/09; B60L 15/20; B60K 1/00; B62D 37/06
USPC 180/65.8; 310/74

(57) ABSTRACT

A hyper-flux flywheel motor system includes a rotor assembly and a number of permanent magnets coupled to the rotor assembly. A stator assembly is rotatably coupled to the rotor assembly and has a core, a number of teeth extending radially from the core, and one or more winding sets, each winding set comprising coils wound on the teeth to interact with the of permanent magnets. A flywheel housing including a frame, and one or more gimbals, houses a flywheel. This flywheel is disposed adjacent to the stator and rotator assembly, rotates about a spin axis, and precesses via the one or more gimbals, in response to rotation of the rotor assembly.

### PRIORITY CLAIM

This application claims the benefit of U.S. provisional patent application No. 61/863,210, filed Aug. 7, 2013.

### FIELD OF THE INVENTION

Embodiments of the invention generally pertain to transportation vehicles, and more particularly to vehicle power balance and stabilization systems.

### BACKGROUND

As the demand for alternative vehicles such as hybrid, electric, and fuel cell vehicles increases, existing technical solutions have become limiting factors in the efficiency of vehicle design. Electric vehicles, for example, utilize electrical motors for propulsion. Some vehicles utilize gyroscopic devices for stability purposes. However, vehicles utilizing both electrical motors and gyroscopic devices increases the space needed for their power solution.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. It should be appreciated that the following figures may not be drawn to scale.

Descriptions of certain details and implementations follow, including a description of the figures, which may depict some or all of the embodiments described below, as well as a discussion of other potential embodiments or implementations of the inventive concepts presented herein. An overview of embodiments of the invention is provided below, followed by a more detailed description with reference to the drawings, in which:

FIG. 1 illustrates an in inline two-wheeled vehicle that may incorporate an embodiment of the invention.

FIG. 2A illustrates a hyper-flux flywheel motor system according to an embodiment of the invention.

FIG. 2B illustrates an embodiment of the invention.

FIG. 3 illustrates a flywheel used in a hyper-flux flywheel motor system according to an embodiment of the invention.

FIG. 4 illustrates a flywheel used in a hyper-flux flywheel motor system according to an embodiment of the invention.

FIG. 5 illustrates a flywheel used in a hyper-flux flywheel motor system according to an embodiment of the invention.

FIG. 6 illustrates a two-mode motor with external rotor assembly.

FIG. 7 illustrates a two-mode motor with an internal rotor assembly according to an embodiment of the invention.

### DESCRIPTION

Embodiments of the invention describe a methods, apparatuses and systems utilizing a rotor assembly, a plurality of permanent magnets coupled to the rotor assembly, and a stator assembly rotatably coupled to the rotor assembly and having a core, a plurality of teeth extending radially from the core, and one or more winding sets, each winding set comprising coils wound on the teeth to interact with the plurality of permanent magnets. A flywheel housing including a frame, one or more gimbals, and a spin axis houses a flywheel. This flywheel is disposed adjacent to the stator and rotator assembly, rotates about the spin axis, and precesses via the one or more gimbals, in response to rotation of the rotor assembly.

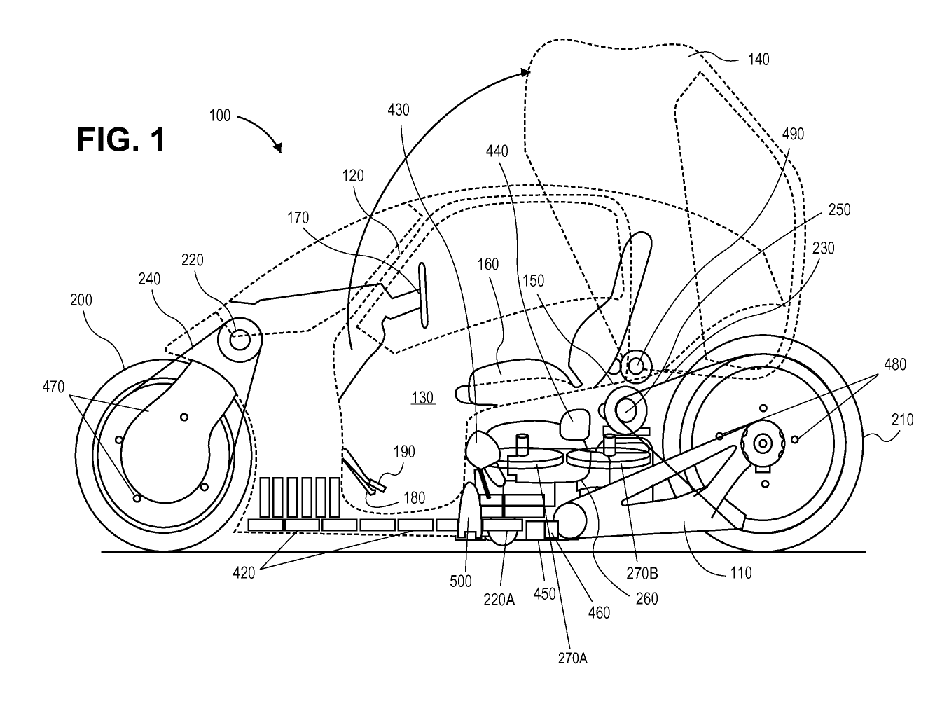

FIG. 1 illustrates an in inline two-wheeled vehicle that may incorporate an embodiment of the invention. In this embodiment, vehicle 100 comprises vehicle frame 110, vehicle body 120 enclosing vehicle interior 130 and access door 140 which rotates open about a hinge mechanism 150. Recumbent operator's seat 160 may be provided with driving controls including steering unit 170, accelerator 180 and brake 190. In this embodiment, said driving controls are arranged in the familiar layout of conventional automobiles having steering wheels and pedals.

In this embodiment, vehicle 100 further includes first and second drive wheels 200 and 210 respectively. First and second drive wheels motor generators 220 and 250 are coupled to drive wheels 200 and 210, respectively, through drive chains 240 and 230, respectively. Said drive wheel motors may include rotors and stators, as described below.

In this embodiment, a gyro stabilizer is coupled to vehicle 100 through vehicle frame 110. Gyro stabilizer may include first and second gyro assemblies housing flywheels 270a and 270b, which in this embodiment are essentially identical. It is to be understood that in other embodiments, the first and second gyro assemblies/flywheels may differ in size and material composition.

Adjacent placement of the stator and the rotor to the outer perimeter of flywheel-motor assembly achieves redundancy through optimized rate of acceleration and deceleration by means of direct torque density control of said flywheel-motor, as described below.

In this embodiment, vehicle 100 further includes an energy storage unit having battery bank 420, capacitor bank 430, and a power switching circuit in electrical communication with battery bank 420, capacitor bank 430, and the drive wheel/flywheel motor-generators 220 and 250 (alternatively referred to herein as a “hyper-flux flywheel motor system”). In one embodiment, battery bank 420 includes battery cells located in locations distributed along vehicle frame 110 so as to distribute the weight and fit within the frame of the vehicle. Battery bank 420 may be charged by plugging into a charging station or electrical wall outlet at a parking space or garage, or one or more battery cells may be physically exchanged to provide a fresh charge.

Vehicle 100 may further include a control system including a plurality of sensors producing electronic signals is illustrated. Said plurality of sensors may indicate at least the absolute state and inertial state of vehicle 100 and the gyro stabilizer. This example control system further includes system controller 440 in electronic communication (via any communication means known in the art) with the plurality of sensors, the drive-wheel/flywheel motor-generators, energy storage unit 410, accelerator 180, brake 190 and steering unit 170. The plurality of sensors include at least three-axis orientation sensor 450 coupled to vehicle frame 110 providing data indicating vehicle rotation and angle, accelerometer 460 coupled to vehicle frame 110 providing data indicating vehicle linear acceleration, first and second drive wheel speed sensors 470 and 480, and a vehicle tilt sensor.

Vehicle 100 further includes mechanical support mechanism 500 (herein referred to as “landing gear”) included in this embodiment may extended to support vehicle 100 when said gyro stabilization units are unable to maintain vehicle stability at a stop—either due to gyro stabilization unit failure or due to a normally ordered shutdown in order to conserve power.

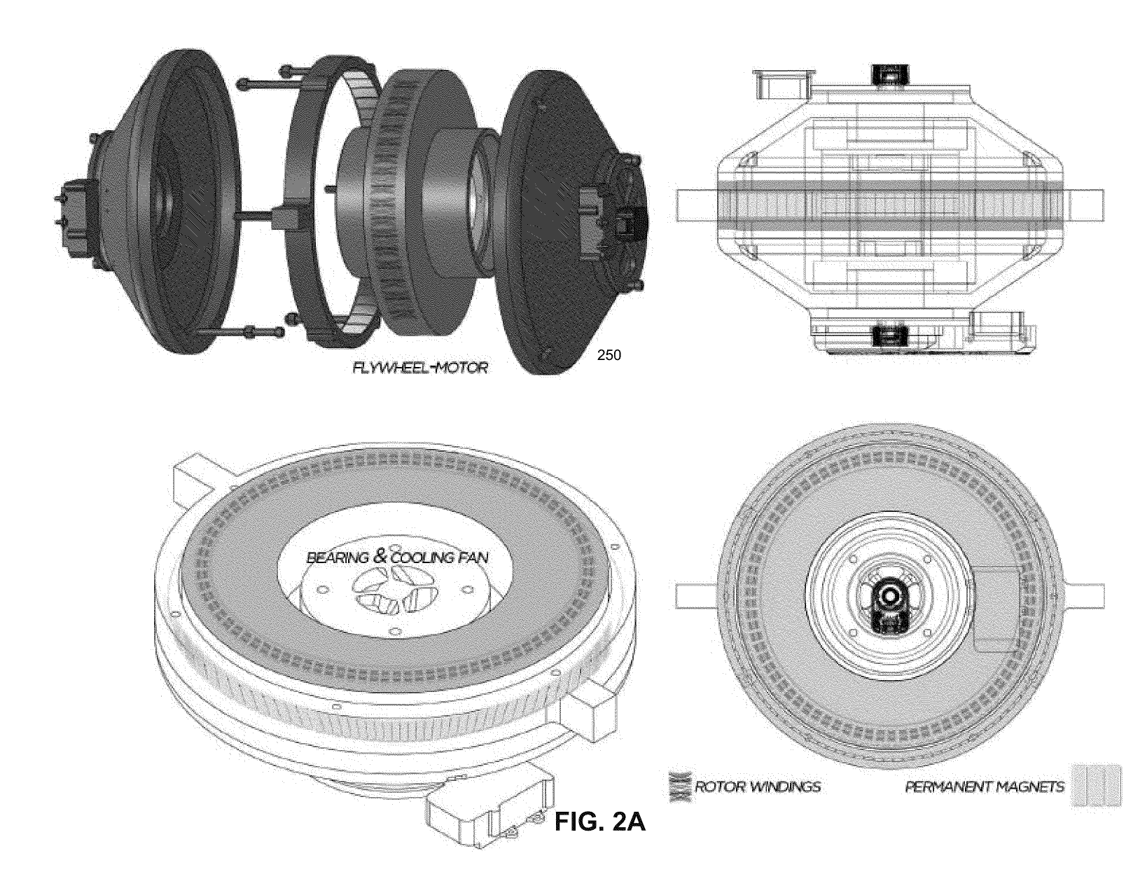

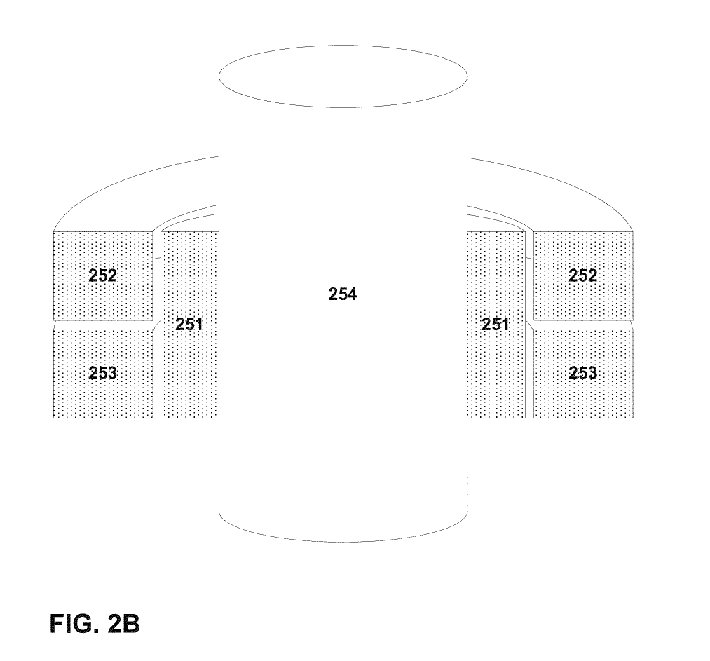

FIG. 2A illustrates one drive wheel/flywheel motor generator, e.g., drive wheel/flywheel motor generator 250, in a hyper-flux flywheel motor system according to an embodiment of the invention. FIG. 2A illustrates a control moment gyroscope system utilizing a brushless, axial-field permanent magnet electric motor in conjunction with a flywheel assembly to achieve optimal self-balancing capabilities through precession as well as kinetic energy storage and recovery in a two-wheel advanced vehicle platform. The concepts of said hyper-flux flywheel motor system are described below.

A used herein a control moment gyroscope (CMG) describes gyroscopic devices included in a housing that supports a gimbal assembly. Said gimbal assembly includes a rotor having an inertial element (e.g., a rotating ring or cylinder) coupled to a shaft. Spin bearings may be disposed around the shaft ends to allow for rotational movement of the shaft, which may be rotated about a spin axis by a spin motor. The gimbal assembly, in turn, may be rotated about a gimbal axis by a torque module assembly mounted to a first end of the CMG housing. To enable the rotational movement of the gimbal assembly, gimbal bearings are disposed between it and the CMG housing. Electrical signals and power may be received by the gimbal assembly via any power controller means known in the art. The CMG may also include any number of sensors (e.g., an encoder, a resolver, a tachometer, etc.) suitable for determining rotational rate and position of the gimbal assembly.

The CMG imparts a specific torque value to the vehicle it is mounted on. Embodiments of the invention utilize said CMG for self-balancing capabilities. For example, flywheels of a vehicle according to embodiments of the invention may receive commands to spin up to “hover speed” (i.e., allowing vehicle 100 of FIG. 1 to “hover” on two wheels without the assistance of landing gear). System controllers may cause gyro stabilization units to precess their flywheels about their gimbals to compensate for imbalanced static loads and dynamic loads while maintaining the host vehicle upright.

Traditional electric motors utilizing magnetic fields apply said field radially—in and away from the rotation axis of the motor. Other designs have said field flowing along the axis of the motor, with the rotor cutting the field lines as it rotates. Such designs are referred to herein as “axial field motors.” These motors allow for much stronger magnetic fields, which in turn, gives power to the motor at lower speeds.

A typical brushless motor has permanent magnets (which rotate) and a fixed armature (e.g., field winding). An electronic controller may continually switch the phase to the windings to keep the motor turning. The controller performs similar timed power distribution by using a solid-state circuit rather than the brush/commutator system.

As described above, gyro stabilizers are coupled to their host vehicle through a vehicle frame. Gyro stabilizers may include gyro assemblies housing flywheels. It is to be understood that said gyro assemblies/flywheels may differ in size and material composition. More specifically, gyro stabilizers may include a flywheel, flywheel motor-generator coupled to the flywheel, a gimbal coupled to the flywheel, and a precession motor having a drive portion coupled to the gimbal and the vehicle frame.

Flywheels contained within a gyro housing may have portions providing a precession axis for precessing the gyro assembly to create the counter-torque that may maintain stability for the host vehicle, as well as a bearing housing to support the flywheel. Said gyro stabilizer may theoretically be located anywhere on the vehicle so long is it can be coupled to the vehicle frame in order to transmit the counter-torque of the precession motors. For example, said gyro stabilizer may be located approximately at the anticipated vertical and fore-aft center of gravity (“CG”) of the host vehicle at standard conditions.

Said electric motor comprises a stator and a rotor in order for rotation in the stator. The stator consists of axially disposed (circumferentially spaced) coils wound on stator bars, and the rotor is provided with permanent magnets to interact with stator coils about a gap of air between stator and rotor.

Adjacent placement of the stator and the rotor to the outer perimeter of the flywheel-motor assembly achieves redundancy through optimized rate of acceleration and deceleration by means of direct torque density control of said flywheel-motor.

Direct torque control is one method used in variable frequency drives to control the torque (and thus finally the speed) of said motors. This involves calculating an estimate of the motor's magnetic flux and torque based on the measured voltage and current of the motor. Direct torque density control allows for the controlling the torque-carrying capability of said flywheel motor.

The mechanical advantage through integrating outer rotor assembly into the gimbal housing consolidates parts thereby increasing efficiency and decreasing complexity. Mounted to the gimbal housing is a precession (torque) motor which allows precession of the flywheel-motor about the gimbal axis, thereby vectoring orthogonal forces stabilizing the two-wheel advanced vehicle.

Embodiments of the invention may also include a housing (for example, shaped as a cylindrical shell) having the above described rotor assembly, plurality of permanent magnets and one or more radial induction bearings between a shaft and the rotor assembly. As shown in FIG. 2B, shaft 254 may function as an inner-stator mounting rod. Ring shaped axial magnets 252 and 253 may be positioned around said shaft and rotor 251, and spaced apart by a given distance. Said axial magnets have opposing magnetic polarities (i.e., magnetic directions). These axial magnets configured as described above may alternatively be referred to herein as electrodynamic bearings. The electrodynamic bearings described above that comprise a passive magnet bearing are produced from relatively straightforward production processes known in the art.

The spatial constraints on the flywheels within gyroscope assemblies that differ from the above described embodiment limit the restoring moment that can be generated at a fixed angular velocity. Once the entire available spatial envelope has been filled, increasing the restoring moment may involve the increase of the angular velocity of the flywheel. Limitations of this angular velocity result from limitations on the speed of the flywheel motor and limitations on the maximum speed and load of the bearings.

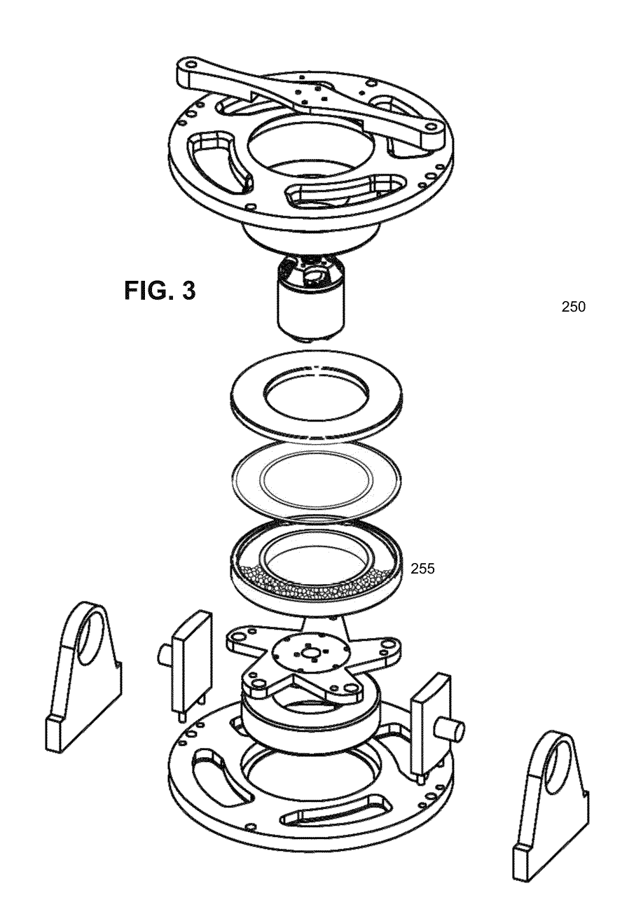

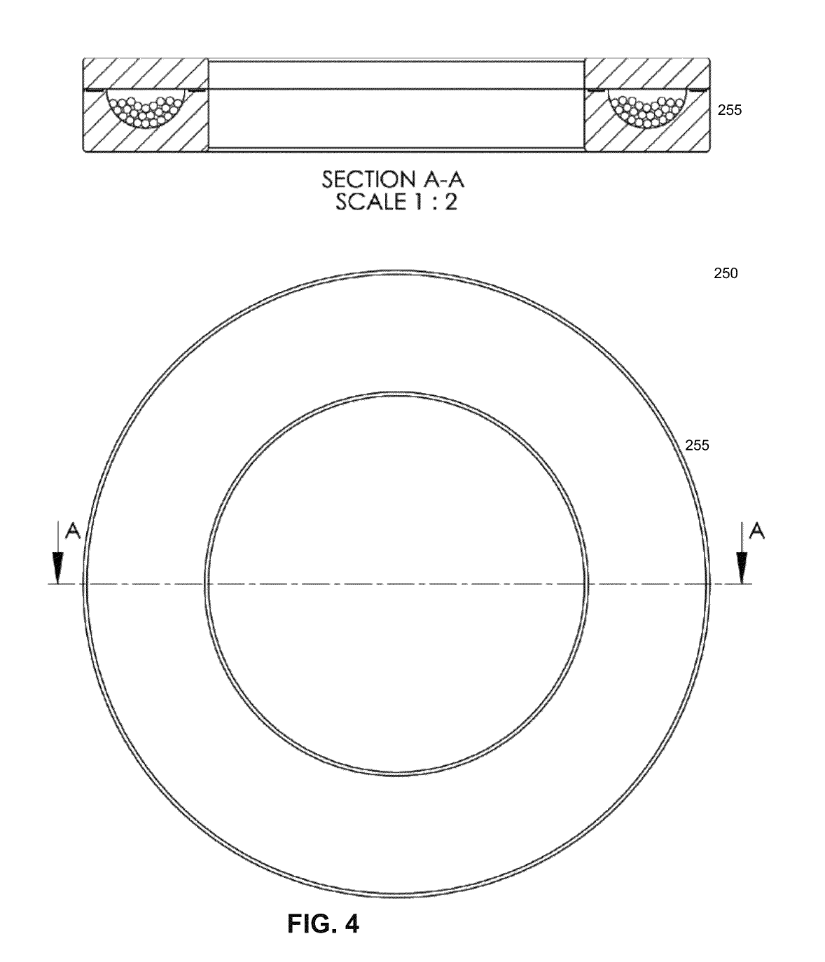

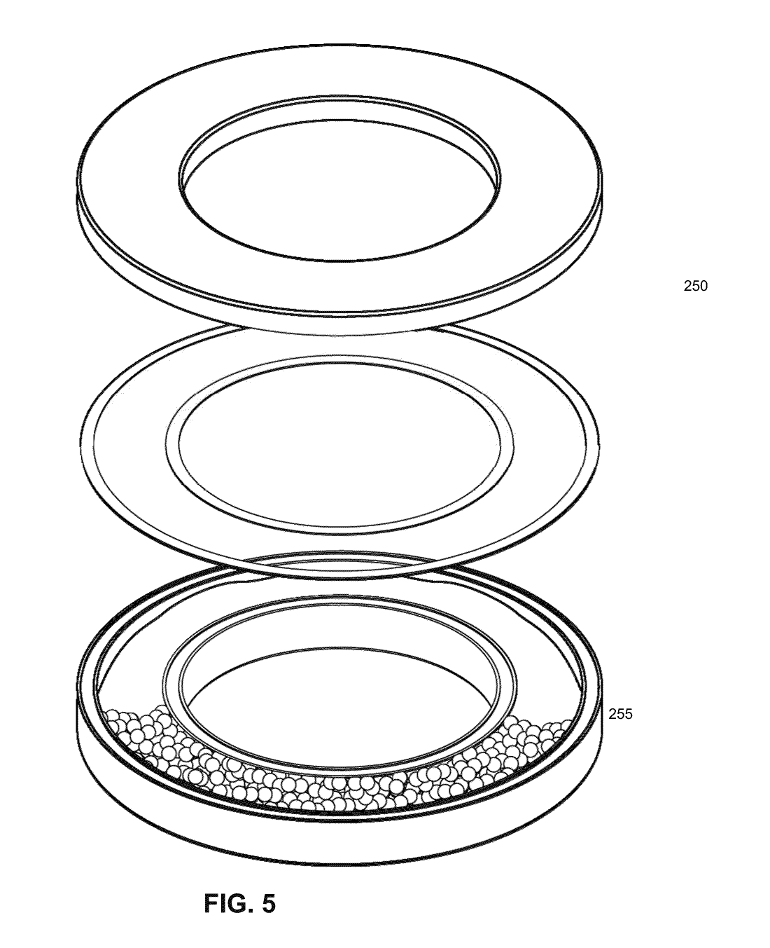

FIGS. 3, 4 and 5 illustrate a flywheel used in one drive wheel/flywheel motor generator, e.g., drive wheel/flywheel motor generator 250, of a hyper-flux flywheel motor system according to embodiments of the invention. These figures illustrate a uniformity and stabilizing system comprising a stabilizing ring 255 used in conjunction with a balanced flywheel wheel assembly. The stabilizing ring 255 may include any suitable liquid or solid material such that the stabilizing ring destroys, absorbs, and dampens vibrations including those caused by non-uniformities in the flywheel. The stabilizing ring 255 comprises either a solid ring or a cartridge having at least one interior chamber, the interior chamber filled with a fluid medium. The stabilizing ring may be used in combination with balancing weights.

In some embodiments, in order for the flywheel to generate precise amounts of torque, flywheels including a stabilizing ring containing a second medium to be distributed throughout the ring when the flywheel rotates about the spin axis are utilized. The stabilizing ring comprises a chamber formed in the flywheel. The medium included in the stabilizing ring may comprise solid material or liquid material.

The basic concept of using gyroscopes to maintain a two-wheeled vehicle upright by using flywheel precession to generate counter-torque is known (while reference is made to gyro-stabilized two-wheeled vehicles in this Specification, the principles of gyro-stabilization may also be used in any vehicles which have a narrow track width such that gyro-stabilization is used to stabilize the vehicle or to augment their suspension system in providing stability); however, such systems have not become common for a variety of reasons, including the lack of a design for a suitable control system for a vehicle to operate safely at highway speeds and in all conditions.

Previous attempts to incorporate flywheel stabilization added great complexity and therefore weight to the vehicles due to the additional mechanical drive-trains, power and fuel (or battery) requirements. Additionally, the flywheels themselves consumed a non-trivial amount of energy and so negated the inherent efficiency advantages of the two-wheeled vehicle itself. However, advances in electric drive systems utilizing motor-generators allow for zero emission power for a vehicle, and provide the ability to use regenerative braking principles to recover greater amounts of energy when slowing down the vehicle. This, combined with advancements in energy storage density, allow for an extended range even with additional power used for gyro-stabilization.

The basic equations governing these effects are known and described by equations. The moment of inertia (I) for a solid disk is given by I=¼*m*r², with m being the mass of the disk and r being the radius. For a given vehicle weight and center of gravity (CG), a gyro stabilizer flywheel may be sized so that the vehicle's vertical stability may be controlled indefinitely while stopped. The radius, the mass, and the geometry of the flywheel may be selected to maintain both a compact size which can fit within the vehicle frame and still be able to provide an effective moment of inertia I.

Causing a rotating flywheel to precess about an axis which is normal to the flywheel axis of rotation will create a counter-torque orthogonal to both the axis of rotation and the axis of precession. The useful counter-torque τ of a gimbaled flywheel assembly is given by the equation: τ=I_{disk}*ω_{disk}*ωₐₓᵢₛ. The rotational velocity of the flywheel plays a large role in the amount of useful torque τ available to stabilize the vehicle. As one of the only controllable variables in the governing equation for a selected flywheel mass and geometry, flywheel rotational velocity can be controlled to compensate for the varying static load and load distribution of the vehicle and consequently the correctional ability of a gyro stabilizer.

Additional variables used in the control of the vehicle include:
θ_{Vehicle} is the tilt of the vehicle from side to side measured in radians
V_{Vehicle} is the velocity of the vehicle as it moves down the road measured in meters per second
ω_{disk} is the rotational velocity of the flywheel measured in radians per second
φₐₓᵢₛ is the tilt of the flywheel from vertical, measured in radians
ωₐₓᵢₛ is the rotational velocity of the tilt of the flywheel, measured in radians per second
θ_{steering} is the steering input, measured in radians

Using inputs θ_{Vehicle}, V_{Vehicle}, ω_{Flywheel}, ωₐₓᵢₛ, φₐₓᵢₛ, and θ_{steering}, the θ_{Vehicle} can be controlled by changing ωₐₓᵢₛ, which outputs a torque orthogonal to φₐₓᵢₛ so as to oppose or increase changes to θ_{Vehicle}. As φₐₓᵢₛ approaches 90° or

$$\frac{π}{2}$$

radians, the gyro's effectiveness in changing θ_{Vehicle} decreases because the torque output is orthogonal to φₐₓᵢₛ. The control of φₐₓᵢₛ and θ_{Vehicle} by actuating ωₐₓᵢₛ can be accomplished by using a modern control system including major and minor loop control or state space. Consequently, two outputs, φₐₓᵢₛ and θ_{Vehicle} may be accounted for at the same time with priority going to ensuring θ_{Vehicle} is stable.

Flywheel geometry and material and precession motor sizing (which determines the correctional ability of the gyro system) may depend on variables such as: the vehicle weight and center of gravity at anticipated load conditions, maximum vehicle speed, maximum turn rate, and anticipated environmental conditions (e.g. cross winds, variations in road gradients, & etc.). In one embodiment, the physical size and mass of the gyro assembly may be as small as possible for packaging and efficiency purposes. Embodiments of the invention may further be utilized by two wheeled vehicles substantially narrower than a traditional car or truck which therefore abides by motorcycle laws. The flywheel mass is selected such that when rotating in the desired speed range, a single flywheel may be capable of correcting an unstable state of the overall vehicle and its contents for an extended period of time. Flywheel material selection is driven primarily by the tradeoffs between material density (δ), material strength, energy storage ability and overall weight. Energy storage (E) is related to moment of inertia and velocity-squared by the equation:

$${E}_{disk} = \frac{1}{2} * {I}_{disk} * {ω}_{disk}^{2} .$$

Higher density material may allow for a smaller overall package, but greater flywheel mass requires larger drive motors and hence greater weight and space requirements.

Additionally, a flywheel with great mass may either be less responsive to acceleration requests (i.e. spinning up to a given speed will take longer) or may require a much larger drive motor to accelerate the flywheel within a given time. The flywheel mass may be optimized to increase efficiency of the vehicle, and minimizing the gyro mass helps to keep the overall vehicle mass lower, which means less energy consumption in operating the vehicle. In one embodiment, the flywheel materials are carbon fiber or Kevlar, selected for their high tensile strength for their weight, allowing higher rotation speeds (i.e. greater than 10,000 rpm) and more responsive acceleration. Higher density materials such as steel, brass, bronze, lead and depleted uranium may also be used; however it is understood that the tensile strength of these materials does not allow for higher rotational speeds which limits their usefulness in minimizing the size and mass of the flywheel.

Based on the geometry of the disc, the moment of inertia can range from

$$\frac{1}{4} * {m}_{disk} * {r}_{disk}^{2} to \frac{1}{2} * {m}_{disk} * {r}_{disk}^{2} .$$

Because the amount of torque output by the precessing gyro is given by τ=I_{disk}*ω_{disk}*ωₐₓᵢₛ, increasing the I_{disk} with the other inputs held constant means a greater τ. Therefore τ may be maximized for a given size and weight constraint to keep the vehicle usable and efficient. However, I_{disk} and ω_{disk} are related because as I_{disk} increases, the motor spinning the gyro needs to become more powerful to achieve the desired ω_{disk} in an acceptable amount of time.

The Output Torque (τ) of the gyro assembly in the X-direction also depends on the Angular Position of the gyro (φₐₓᵢₛ). Output Torque (τ) is maximized when the gyro's rotation is pointed vertically down or up. As the ωₐₓᵢₛ increases, the gyro disc's rotation direction will move faster towards or away from vertical. If the vehicle needs to be stabilized for a longer period of time, the ωₐₓᵢₛ may be minimized to maximize the amount of time that an acceptable Output Torque (τ) is produced.

When the vehicle is coming to a stop and has low forward velocity (and therefore low rotation speed of the wheels), the torque in the forward direction exerted by the lean of the vehicle is described by the equation Mₓ=r*f*Sin(θ_{Vehicle}), where r is the height of the center of gravity for the vehicle, f is the force of gravity on the vehicle, and θ_{Vehicle} is the amount of lean from vertical. The moment exerted by the precession of a flywheel is described by the equation Mₓ=I_{disk}*ω_{disk}*ωₐₓᵢₛ*Sin(θ_{diskaxis}). For a nominal 500 kg vehicle moving at low speeds, the moment exerted by a vehicle with a center of gravity 0.75 m above the ground and tipping 30 degrees from vertical is 1131 N-m. To keep the vehicle stable would therefore require 1131 N-m of counter-torque, but to move the vehicle upright, an excess of counter-torque may be required. In order to counter that tipping motion, a moment Mₓ may need to be introduced by precessing the gyro stabilizer flywheel. If multiple flywheels are utilized, their moments are additive.

A lean of 30 degrees is more than one would deal with in real world situations not involving a failure of the stability system, so a flywheel disk approximately of 7 kg with a radius of 0.15 m and a moment inertia of 0.070 kg-m-m, spinning at 1570 rad/s, and precessing at 10.47 rad/s, with its axis vertical should exert a moment of 1295 N-m. In one embodiment, two identical flywheels are used, spinning in opposite directions and precessing in opposite directions so that the moment is exerted in the same direction, but the yaw moment M_{z} of the two flywheels together would equal zero. The flywheels may each be sized such that in the case of the failure of one flywheel, the remaining flywheel is able to stabilize the vehicle in most situations. Therefore, for the nominal 500 kg vehicle under the conditions described above, having a rolling moment of 1131 N-m, two flywheels would produce 2590 N-m of counter-torque which would be sufficient to maintain or correct the lean of the vehicle, and in the event of a partial failure of one flywheel the remaining flywheel could provide sufficient correctional moment to control the vehicle to place it in a safe condition. The flywheels may also be of equal size, or differing sizes.

Thus, it is to be understood that, at least in light of the above description and the figures below, embodiments of the invention describe an apparatus and methods to receive, via a plurality of sensors, data to indicate information describing a vehicle state. This information may include, but is not limited to, orientation of the vehicle frame, orientation of a front wheel of the vehicle with respect to the frame, orientation and rotational speed of gyroscope flywheels included in the vehicle (i.e., gyroscopes coupled to the vehicle frame), and the current speed of the vehicle. Said gyroscopes may be aligned lengthwise with respect to the front and rear wheel of the vehicle, widthwise with respect to the frame of the vehicle (e.g., side-by-side), or heightwise with respect to the frame of the vehicle (e.g., stacked).

Based at least in part on data received from said sensors, the orientation or the rotational speed of (at least) one of the flywheels may be adjusted. Embodiments of the invention may further adjust the orientation or the rotational speed of (at least) one of the flywheels further based on an input to change the speed (e.g., acceleration or brake input) or direction (e.g., steering wheel input) of the vehicle. For example, embodiments of the invention may cause the rotational speed of one of the flywheels to be reduced when an acceleration input is detected, or cause the rotational speed of one of the flywheels to be increased when a brake input (i.e., an input to engage a front or rear wheel brake) is detected; if it is determined the vehicle will execute a turn (i.e., the orientation of the front wheel with respect to the frame is detected), embodiments of the invention may adjust the orientation or the rotational speed of at least one of the flywheels to maintain stability during the turn.

Using gyro stabilizer flywheels to receive and transfer energy back into a drive system provides the advantages of a lighter weight and more efficient two-wheel vehicle which can include an all weather interior cabin having recumbent seating, with the high energy efficiency of a regenerative braking system and zero emissions propulsion. Transferring energy between the flywheels motor(s)/generator(s) and the drive wheel motor(s)/generator(s) through the energy storage unit during vehicle's acceleration and deceleration maintains up to 95% energy efficiency and vehicle stability, thereby substantially increasing the range of the vehicle. A gyro stabilized vehicle without this power transfer system may be significantly handicapped due to the increased power requirements of the gyro stabilizer compared to a conventional non-stabilized vehicle.

Lower speed urban travel is generally the most energy intensive regime for traditional vehicles, due to the energy lost in frequent braking and acceleration (both from the energy input into the brakes, and the energy used to accelerate the vehicle that is lost to subsequent braking). Therefore, it is to be understood that a great leap in energy efficiency may be achieved by providing a gyro-stabilized vehicle that can travel on two-wheels, accommodate recumbent passenger arrangements, provide the safety of an all-weather enclosed passenger cabin, provide driving controls similar to a conventional car, and which can greatly improve the range and efficiency of a gyro-stabilized vehicle by integrating the stabilizing flywheels into a regenerative braking system.

At lower speeds, such as when the vehicle is accelerating from a stop or slowing to a stop, or at speeds common in urban areas and stop-and-go traffic situations, the self stabilization properties of the vehicle are not sufficient to maintain the upright orientation of the vehicle. Consequently, in the prior art much more skill is required from the rider to operate the unstabilized vehicle, and the rider may be required to use his or her own physical strength to balance the vehicle at a stop diminishing the utility and equal accessibility.

Gyro-stabilization at low speeds and at stop also presents a simpler control problem than that encountered at higher speeds. A gyro stabilizer may be mounted to a vehicle through gimbal mountings, utilizing the gimbal motors to precess the gyros to create counter-torque against vehicle roll moment. Vehicle state can be measured by inertial and absolute position sensors mounted to the vehicle which can then be used to determine the amount and rate of precession required to provide sufficient counter-torque to maintain the vehicle upright. Generally, the restorative ability of the gyro stabilizer may be able to stabilize a vehicle with a passenger for a sufficient amount of time such as may be encountered at a stop light or stop sign. In one embodiment, when the vehicle is stopped for prolonged periods or turned off, the vehicle may support itself by an automatically deployed mechanical support.

In one embodiment, the gyro stabilizer flywheel(s) and drive wheel(s) are coupled to their own respective motor-generator(s) which can operate in a motor-mode to drive their respective loads, or switch to a generator-mode to slow the rotating loads and harvest this energy for transfer to other loads. The electrical power system includes an energy storage unit to provide temporary storage of electrical energy while transferring it between the drive/braking system and the gyro stabilizer flywheels or for longer durations of time such as when the vehicle is powered off.

A system controller receives sensor data from the vehicle's state sensors (inertial and absolute), the gyro stabilizer's state sensors, and other parameters to control the amount and timing of correctional torque imparted by the gyro stabilizer.

A gyro stabilizer includes at least one actively gimbaled flywheel coupled to a vehicle. In one embodiment, a gyro stabilizer includes first and second counter-rotating flywheels which are independently gimbaled. Each flywheel may be mounted with a vertical axis of rotation in a neutral position and with the gimbal axes parallel to each other. In this embodiment, the counter-rotating flywheels are precessed in opposite directions, such that their counter-torque is additive, but their yaw effects on the vehicle cancel each other.

Use of two flywheels also allows each individual flywheel to be made more compact in order to fit within the narrow frame of the vehicle. Additionally, in the event one flywheel fails, the second flywheel can be used to provide adequate stability during an emergency stop of the vehicle to place it in a safe condition. In the case of either flywheel failure or emergency balance situation, a failsafe protocol engaging the deployment to the mechanical landing gear may be used to keep the vehicle upright and maintain the driver's safety.

Embodiments of the invention further describe a rotor assembly and a stator assembly rotatably coupled to the rotor assembly. Said stator assembly includes a core, a plurality of teeth extending radially from the core, and at least two winding sets, each winding set comprising coils wound on the teeth. The at least two winding sets includes a first set for driving the rotor assembly to a first variable operational range, and a second set for driving the rotor assembly to a second variable operational range different than the first. Said rotor assembly may be used in an electric motor (i.e., said rotor assembly is a flywheel), or may be used in a drive motor.

In some embodiments of the invention, the first set of windings comprises a first number of coils wound on the teeth, and the second set of windings comprises a second number of coils, greater than the first number, wound on the teeth. The first and second set of windings may be wound on alternating teeth of the stator. Said stator teeth may extend either outward or inward from the core.

In some embodiments, the above described first and second variable operational ranges comprise rotor speeds (e.g., the first range may be for 0-500 RPMs, while the second range may be for 500+ RPMs). In other embodiments, the first and second operational ranges comprise power efficiency ranges (e.g., the power-in/power-out percentage of the first range may be 85%, while the power-in/power-out percentage of the second range may be 90%).

Throughout this specification, several terms of art are used. These terms are to take on their ordinary meaning in the art from which they come, unless specifically defined herein or the context of their use would clearly suggest otherwise. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

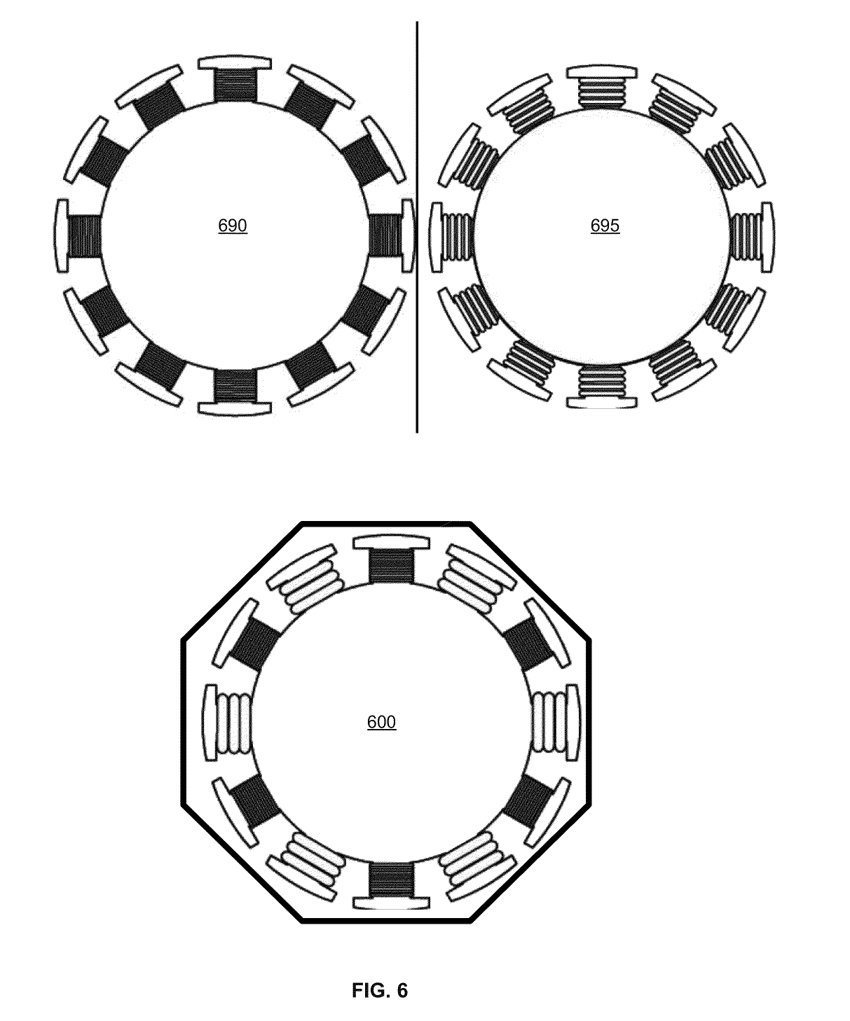

FIG. 6 is an illustration of an embodiment of the invention. In this embodiment, flywheel motor 600, which may be used for vehicular energy storage as described below, has multiple operating modes. Each of these modes has different requirements and creating an appropriate singular design in order to meet all of these modes does not exist in prior art solutions (i.e., separate motors, such as prior art motors 690 and 695, would have to be utilized). Motor 600 comprises more than one set of coil windings, each with different parameters to allow for better meeting each of these modes.

In this embodiment, one mode is a start-up/energy injection/energy recovery mode (i.e., the mode accomplished by the windings similar to that on motor 695). The requirements for optimal work in this mode include the ability to transmit very large amounts of power quickly. One way of achieving this is to use larger diameter wires with fewer turns per stator pole. A second mode is a low power, high speed, low change mode. For this mode, smaller diameter wires with more windings may be optimal (i.e., by windings similar to that on motor 690).

There are other possible modes between the two extremes and a level of granularity can be achieved by using multiple sets of windings around the same stator teeth, or by having non-connected sets around adjacent or non-adjacent teeth. In some embodiments, multiple modes may be formed on a wheel having a quantity of stator teeth divisible by six (e.g., twelve stator teeth for two modes of operation, as shown in motor 600, eighteen stator teeth for three modes of operation, etc.)

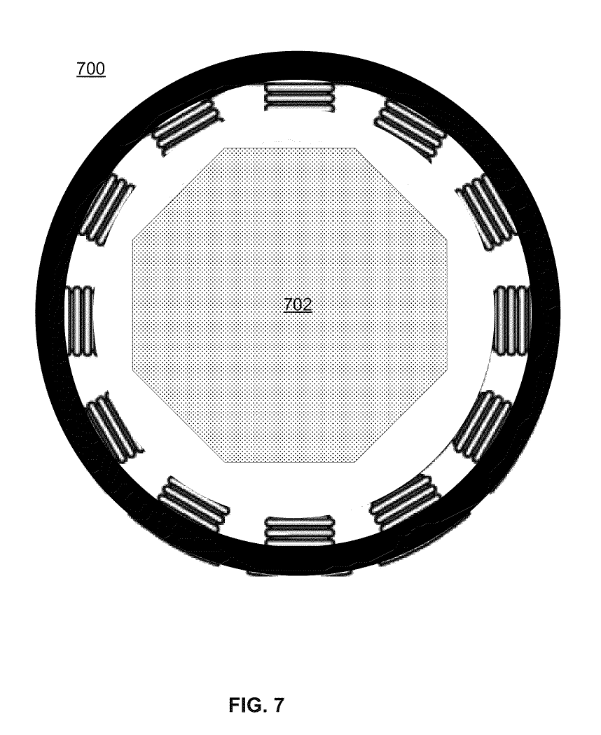

While FIG. 6 is an illustration of a two-mode motor with external rotor assembly 602, FIG. 7 is an illustration of two-mode motor 700 with internal rotor assembly 702 according to an embodiment of the invention. It is to understood that the windings illustrated in FIG. 7 are not necessarily drawn to scale, and that they may vary in various embodiments as described above.

Throughout this specification, several terms of art are used. These terms are to take on their ordinary meaning in the art from which they come, unless specifically defined herein or the context of their use would clearly suggest otherwise. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Various components referred to above as processes, servers, or tools described herein may be a means for performing the functions described. Each component described herein includes software or hardware, or a combination of these. The components may be implemented as software modules, hardware modules, special-purpose hardware (e.g., application specific hardware, ASICs, DSPs, etc.), embedded controllers, hardwired circuitry, etc.

Software content (e.g., data, instructions, configuration) may be provided via an article of manufacture including a computer storage readable medium, which provides content that represents instructions that may be executed. The content may result in a computer performing various functions/operations described herein. A computer readable storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable storage medium may also include a storage or database from which content may be downloaded. A computer readable storage medium may also include a device or product having content stored thereon at a time of sale or delivery. Thus, delivering a device with stored content, or offering content for download over a communication medium may be understood as providing an article of manufacture with such content described herein.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

Methods and processes, although shown in a particular sequence or order, unless otherwise specified, the order of the actions may be modified. Thus, the methods and processes described above should be understood only as examples, and may be performed in a different order, and some actions may be performed in parallel. Additionally, one or more actions may be omitted in various embodiments of the invention; thus, not all actions are required in every implementation. Other process flows are possible.

1. An apparatus comprising:
a rotor assembly;
a plurality of permanent magnets coupled to the rotor assembly;
a stator assembly rotatably coupled to the rotor assembly and having a core, a plurality of teeth extending radially from the core, and one or more winding sets, each winding set comprising coils wound on the teeth to interact with the plurality of permanent magnets;
a flywheel housing including a frame, one or more gimbals, and a spin axis; and
a flywheel, disposed adjacent to the stator and rotator assembly, to rotate about the spin axis and to be precessed via the one or more gimbals, in response to rotation of the rotor assembly.

2. The apparatus of claim 2, further comprising:
a housing including the rotor assembly and the plurality of permanent magnets, wherein the plurality of permanent magnets comprise ring shaped axial magnets to function as electromagnetic bearings for the rotor assembly.

3. The apparatus of claim 1, wherein the flywheel further comprises:
a stabilizing ring including a medium to be distributed throughout the ring when the flywheel rotates about the spin axis.

4. The apparatus of claim 3, wherein the stabilizing ring comprises a chamber formed in the flywheel.

5. The apparatus of claim 3, wherein the medium of the stabilization ring comprises solid material.

6. The apparatus of claim 3, wherein the medium of the stabilization ring comprises liquid material.

7. The apparatus of claim 1, wherein the flywheel is comprised of at least one of carbon fiber, Kevlar, steel, brass, bronze, lead and depleted uranium.

8. The apparatus of claim 1, wherein the stator assembly comprises at least two winding sets, including a first set for driving the rotor assembly to a first variable operational range, and a second set for driving the rotor assembly to a second variable operational range different than the first.

9. The apparatus of claim 8, wherein the first set of windings comprises a first number of coils wound on the teeth, and the second set of windings comprises a second number of coils, greater than the first number, wound on the teeth.

10. The apparatus of claim 8, wherein the first and second set of windings are wound on alternating teeth of the stator.

11. The apparatus of claim 8, wherein the first and second variable operational ranges comprise rotor speeds.

12. The apparatus of claim 8, wherein the first and second operational ranges comprise power efficiency ranges.

13. The apparatus of claim 8, wherein the rotor assembly comprises an electric motor flywheel.

14. The apparatus of claim 8, wherein the rotor assembly comprises a drive motor wheel.

15. The apparatus of claim 8, wherein the stator teeth extend outward from the core.

16. The apparatus of claim 8, wherein the stator teeth extend inward from the core.

17. A vehicle comprising:
a frame;
a front wheel and a rear wheel coupled to the frame;
a hyper-flux flywheel motor system as defined by any of claims 1-15;
a plurality of sensors to detect orientation of the frame, orientation of the front wheel with respect to the frame, orientation and rotational speed of the flywheel, and speed of the vehicle; and
an electronic control system to adjust at least one of the orientation and rotational speed of the flywheel based, at least in part, on data from the plurality of sensors and an input to change at least one of speed and direction of the vehicle.
